(19) United States
(12) Patent Application Publication
(10) Pub. No.: US 2011/0006136 A1
(43) Pub. Date: Jan. 13, 2011

(54) Lower Fuel Injector Filter

(76) Inventors: Vicki A. Flynn, Penfield, NY (US); Stefan O. Fedunyszyn, Webster, NY (US); Dominic N. Dalo, Rochester, NY (US); Paul A. Wheeler, Rochester, NY (US); Otto Muller-Girard, JR., Rochester, NY (US); Cynthia J. Baron, Fairport, NY (US)

Correspondence Address: DELPHI TECHNOLOGIES, INC, M/C 480-410-202, PO BOX 5052, TROY, MI, 48007, US

(21) Appl. No.: 12/498,408

(22) Filed: Jul. 7, 2009

(51) Int. Cl. B05B 1/30

(52) U.S. Cl. 239/575; 239/584

(57) ABSTRACT

A lower fuel injector filter includes a generally planar disk having an annular shape and including a plurality of filter holes. The disk is retained by a valve guide within a valve seat. The disk prevents internally generated contamination particles contained in fuel flowing through the filter holes from reaching a valve and seat interface positioned downstream of the valve guide. The disk may also be retained by a ball valve stop proximate the valve seat.

### TECHNICAL FIELD

The present invention relates to fuel injection systems for internal combustion engines; more particularly, to fuel injectors; and most particularly, to a lower filter retained proximate a valve seat of a fuel injector.

### BACKGROUND OF THE INVENTION

Fuel injected internal combustion engines are well known. Fuel injection systems may be divided generally into multi-port fuel injection, wherein fuel is injected into a runner of an intake manifold ahead of a cylinder intake valve, and direct injection, wherein fuel is injected directly into the combustion chamber of an engine cylinder, typically during or at the end of the compression stroke of the piston.

An internal valve assembly of a fuel injector used in either type of system typically includes a valve seat and a reciprocably actuated valve for mating with the seat. It is most desirable, in a modern internal combustion engine, to precisely control the flow of fuel to the combustion chamber in order to meet performance requirements as well as emission regulations. Therefore, it is desirable to ensure that the valve completely seals against the seat when the valve assembly is in a closed position to avoid fuel passage when not needed.

It is known to position an upper filter proximate to a fuel inlet of the injector. While such an upper filter may capture contaminants generated upstream of the fuel injector that could prevent a valve from properly seating, it can not capture contaminants from within the injector that may have been introduced during the assembly of the injector or from wear and abrasion of internal injector components.

Contamination lodged between the valve and seat may allow fuel to pass through the injector when it is not commanded. The resultant fuel leakage may increase emissions, cause poor engine operation, or cause a hydraulic lock of the engine.

In order to reduce contamination of internal origin, lower filters have been disposed between the fuel inlet and the internal valve assembly in the prior art. Typically, additional components are needed to retain such a lower filter. While the lower filters of the prior art may prevent internally generated contamination from reaching the valve and the seat, integration of such lower filters into the fuel injector assembly add a multitude of assembly process steps and has been proven to be labor intensive and expensive.

What is needed in the art is a lower fuel injector filter positioned in close proximity to the valve/valve seat sealing area that does not require additional assembly components and that can be assembled with a reduced number of assembly steps compared to the existing prior art filters.

It is a principal object of the present invention to provide a lower fuel injector filter that is retained by a valve guide of an internal valve assembly of a fuel injector.

### SUMMARY OF THE INVENTION

Briefly described, in a fuel injector having a circular valve seat and a reciprocably actuated ball valve, a lower fuel injector filter is placed proximate the valve/seat either within or below a valve guide or within a ball valve stop. The lower fuel injector filter may have the geometric shape of a flat disk and includes a plurality of filter holes. By integrating the lower filter with the valve guide or ball valve stop, the need for additional components to retain the lower filter within the fuel injector, as in the prior art, can be eliminated. Furthermore, by placing the lower filter in accordance with the invention, the filter is positioned in close proximity to the interface of the valve and the valve seat enabling the filter to capture and contain internally generated contamination particles immediately before they are to pass into the valve and seat interface thereby protecting the valve/seat interface from particles originating from anywhere within the injector.

In one aspect of the invention, the lower filter is crimped into the guide using a relatively simple crimp tool. During the crimping process, the inner or outer flange of the valve guide is deformed over the filter to retain the filter within the guide.

In another aspect of the invention, the lower filter is press fitted into the valve guide. The filter has oversized outside and/or inside diameters and is pressed into the valve guide by a press tool. In addition to the press fit assembly of the filter, the outside flanges of the valve guide may be deformed inward during the press of the guide into the seat blank during assembly.

In still another aspect of the invention, the lower filter may be captured between the valve guide and the valve seat and, therefore, may be positioned under the guide and in direct contact with the guide.

In yet another aspect of the invention, the lower filter my be crimped or press-fitted into a ball valve stop.

While the lower fuel injector filter in accordance with the invention may be used in multi-port fuel injection injectors, and in direct injection fuel injectors, multi-port fuel injectors have a particular need for such a filter since, due to the lower fuel pressure compared to direct injection, there is a higher possibility for contaminants remaining lodged at the valve and seat interface.

### BRIEF DESCRIPTION OF THE DRAWINGS

The present invention will now be described, by way of example, with reference to the accompanying drawings, in which:

FIG. 1a is an isometric view of a lower filter, in accordance with the invention;

FIG. 1b is an enlarged partial view of a filter hole area enclosed by circle 1b in FIG. 1a, in accordance with the invention;

FIG. 1c is a partial cross-sectional view along line 1c-1c in FIG. 1a, in accordance with the invention;

FIG. 2 is a cross-sectional side view of a cartridge assembly of a fuel injector, in accordance with the invention;

FIG. 3 is a cross-sectional view of a seat and guide assembly with the filter crimped or pressed into the guide, in accordance with the invention;

FIG. 4 is a top plan view of the seat and guide assembly with the filter crimped into the guide, in accordance with the invention;

FIG. 5 is a cross-sectional view of a seat and guide assembly with the filter captured under the guide, in accordance with the invention;

FIG. 6a is a cross-sectional view of an outlet end of a fuel injector including a ball stop with the filter captured by the ball stop, in accordance with the invention; and

FIG. 6b is a close-up view of the ball stop and filter sub-assembly shown in FIG. 6a, in accordance with the invention.

Corresponding reference characters indicate corresponding parts throughout the several views. The exemplification set out herein illustrates a referred embodiment of the invention, in one form, and such exemplification is not to be construed as limiting the scope of the invention in any manner.

### DESCRIPTION OF THE PREFERRED EMBODIMENTS

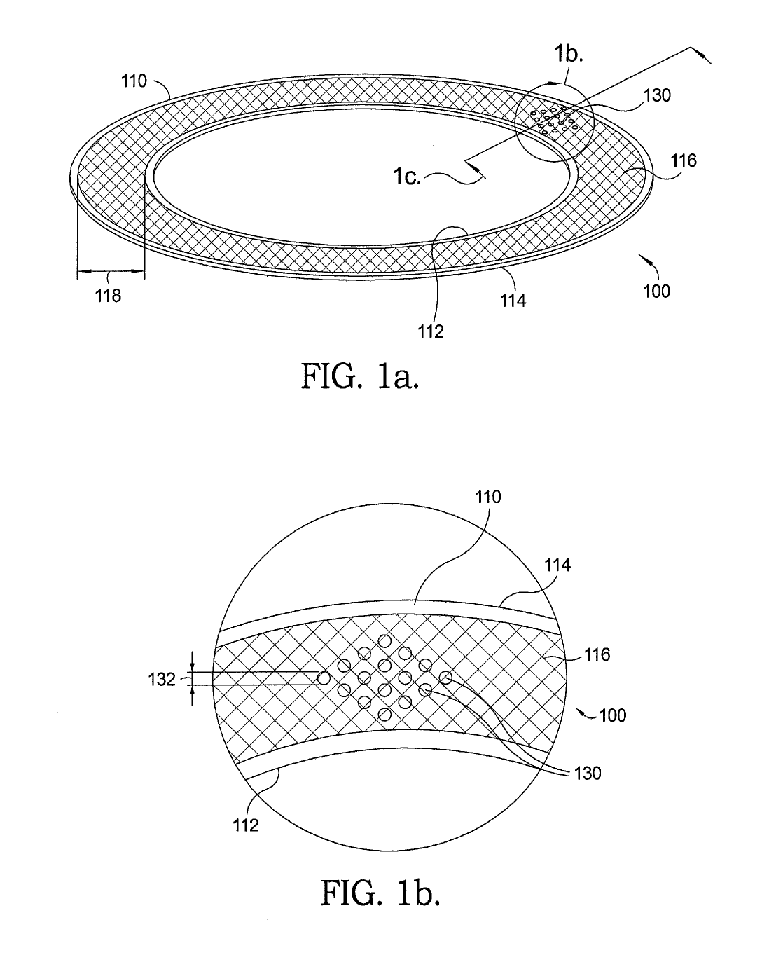

Referring to FIGS. 1a through 1c, a lower filter 100 is a generally planar disk 110 that has a ring-like annular shape including an inner diameter 112 and an outer diameter 114. Lower filter 100 includes a circular filter hole area 116 extending for a width 118 between inner diameter 112 and outer diameter 114. Disk 110 has a thickness 122 that is preferably the same across the entire cross-section including filter hole area 116 as shown in FIG. 1c. Thickness 122 of disk 110 is preferably chosen such that the rigidity of disk 110 is ensured and such that disk 110 is self-supporting. Therefore, lower filter 100 is able to withstand the flow of a fluid through filter hole area 116 without additional axial downstream support. It may be possible to form filter hole area 116 to have a reduced thickness compared to the remainder of disk 110. Filter hole area is preferably positioned centered between inner diameter 112 and outer diameter 114. Disk 110 may be, for example, formed from stainless steel.

Filter hole area 116, shown in detail in FIG. 1b, includes a plurality of filter holes 130. Filter holes 130 may be, for example, photochemically etched holes. It may further be possible to form filter holes 130 in disk 110 by laser drilling, stamping, or other machining operations.

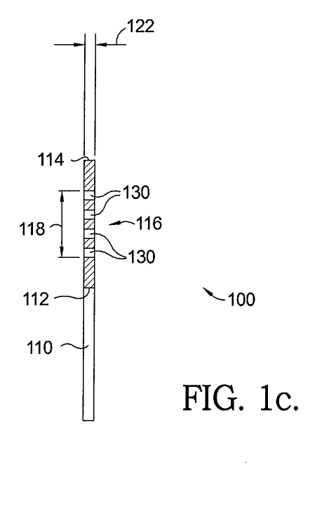

To maximize fuel flow through a fuel injector and the filter efficiency of lower filter 100, as many filter holes 130 as desired without reducing the stability of disk 110 may be formed in filter hole area 116. Filter holes 130 have a width such as diameter 132 that may be the same for each of the filter holes 130 or that may not be the same for each of the filter holes 130. The diameter 132 of filter holes 130 is preferably smaller than the largest possible distance between a valve, such as valve 214, and a seat, such as seat 212, when an internal valve assembly, such as valve assembly 210 (shown in FIG. 2) is in an open position. Filter holes 130 may be grouped and/or arranged in a pattern, for example in a rhombus as shown in FIG. 1b. Other patterns or hole shapes are possible and the pattern of filter holes 130 may depend on the forming process of filter holes 130 in disk 110.

Referring to FIG. 2, a cartridge assembly of a fuel injector 200 extends axially from a fuel inlet end 202 to a fuel outlet end 204, encloses a fuel passage 206, and includes an internal valve assembly 210 positioned upstream of and proximate to fuel outlet end 204 within fuel injector 200. Fuel injector 200 may be a fuel injector for multi-port fuel injection, for example, as shown in FIG. 2, or a fuel injector for direct injection.

A lower body 208 of fuel injector 200 houses internal valve assembly 210. Internal valve assembly 210 includes a reciprocably actuated valve 214, such as a ball, adapted for mating with a valve seat 212, such as a beveled circular seat, at a valve and seat interface 216 and a shaft 218 extending axially from valve 214. Shaft 218 may be hollow. Internal valve assembly 210 regulates the fuel flow through fuel outlet end 204. When internal valve assembly 210 is in a closed position, valve 214 seals against seat 212 at the valve and seat interface 216. A guide 220 that radially guides valve 214 is positioned in close proximity to and upstream of valve and seat interface 216 within seat 212.

Lower filter 100, as shown in detail in FIGS. 1a through 1c, is retained by guide 220 within seat 212 to capture contamination particulates that may be generated internally in the injector 200 and that may be harmful to the injector operation before reaching valve and seat interface 216. Fuel injector 200 may further include an upper filter 209 positioned in close proximity to fuel inlet end 202 filtering the fuel entering fuel injector 200.

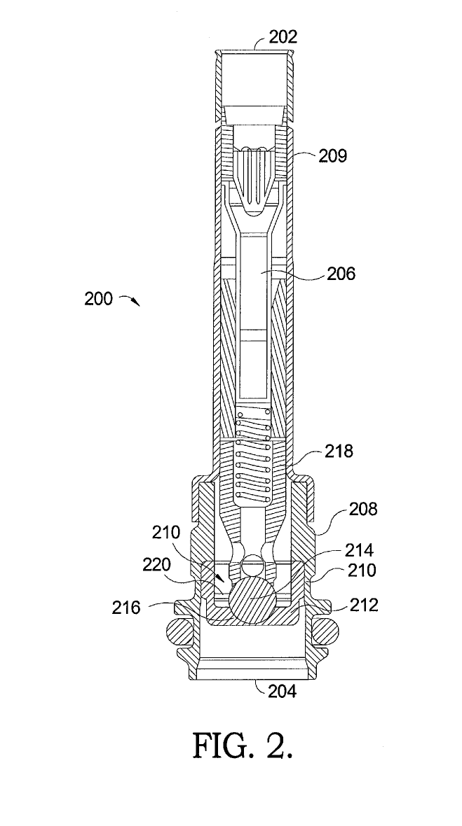

Referring to FIG. 3, lower filter 100 is shown assembled within guide 220 and guide 220 is shown assembled in seat 212 of fuel injector 200. Guide 220 is designed as a ring that has a u-shaped cross-section. Guide 220 includes an inner flange 222 and an outer flange 224 connected at an end by a bottom wall 226 forming the u-shaped cross-section. Inner flange 222, outer flange 224, and bottom wall 226 have preferably the same thickness. A plurality of flow through holes 228 is included in bottom wall 226 that allows fuel flow through guide 220. The inner diameter of inner flange 222 guides valve 214 and inner flange 222 may, therefore, have a larger height than outer flange 224. Guide 220 may further be designed such that inner flange 222 and outer flange 224 have the same height or such that outer flange 224 has a larger height than inner flange 222. Guide 220 has an outer diameter that is adapted to be received by seat 212. Guide 220 may be press fitted into an inner circumferential contour of seat 212. Guide 220 may be assembled in seat 212 such that bottom wall 226 faces fuel outlet end 204 of fuel injector 200 (as shown in FIG. 2) or such that bottom wall 226 faces fuel inlet end 204.

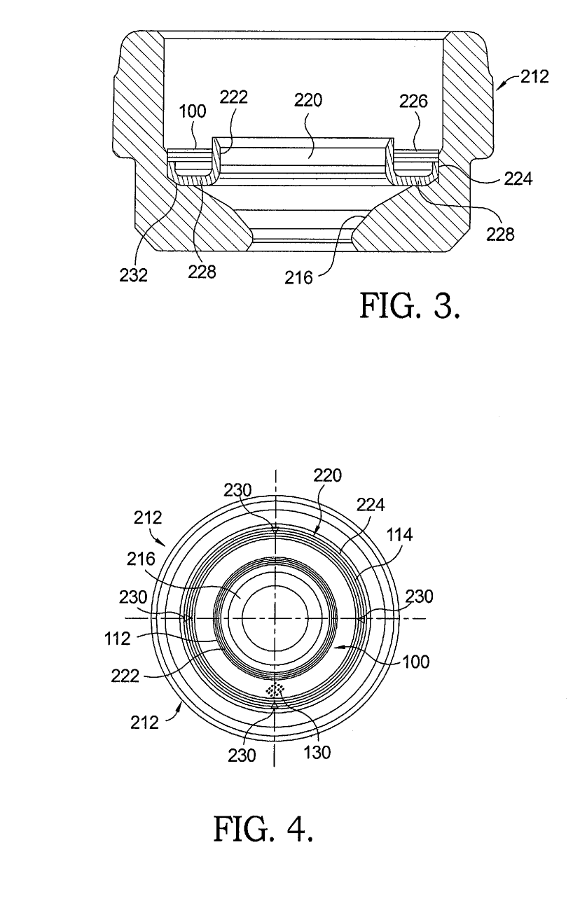

As shown in FIGS. 3 and 4, lower filter 100 may be assembled within guide 220 by either crimping or press fitting and may, therefore, be radially supported by guide 220. Since lower filter 100 is self-supporting, no axial downstream support is needed.

During the crimping process, outer flange 224 of guide 220 is deformed such that a crimp 230 is formed that partially extends over outer diameter 114 of lower filter 100 as shown in detail in FIG. 4. Alternatively, a crimp may be formed extending radially outward from inner flange 222 to partially extend over inner diameter 112 of lower filter 100. A crimping tool that may include, for example, four evenly distributed features may be used to concurrently deform either the inner flange 222 or the outer flange 224 of guide 220 upon application of an axial load. As shown in FIG. 4, a crimp 230 having, for example a triangular shape, may be formed by the crimping tool. While guide retention of lower filter 100 is shown in FIG. 4 with four crimps 230 positioned at equally spaced locations, more or fewer locations may be chosen as well as an uneven distribution of the crimps 230.

When lower filter 100 is press fitted into guide 220, a slightly oversized disk 110 may be used that has a larger outer diameter 224 and a smaller inner diameter 112 than a lower filter 100 that is used for the crimp retention. A press tool may be used to apply an evenly distributed axial load when lower filter 100 is pressed into guide 220.

Lower filter 100 is preferably assembled, either by crimping or press fitting, within guide 220 after guide 220 is pressed into the seat blank and after the seat finish operations have been completed, but it may be possible to assemble lower filter 100 into guide 220 prior to the seat finishing operations. If so, the outer flange 224 of guide 220 may be deformed inward during the press fitting of guide 220 into seat 212. The deformed flange 224 would assist retaining the filter 100 inside guide 220 and a smaller interference fit compared to using press fitting alone may be sufficient.

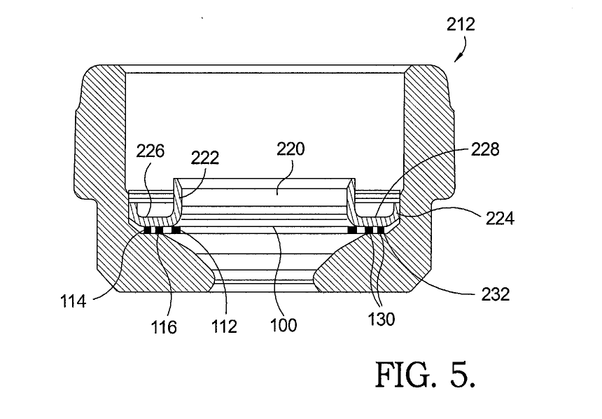

Referring to FIG. 5, lower filter 100 is shown assembled below guide 220 and guide 220 is shown assembled in seat 212 of fuel injector 200. Lower filter 100 is received by a shoulder 232 of seat 212 that typically supports guide 220. Shoulder 232 provides axial and radial support for lower filter 100. Inner diameter 212 of lower filter 100 is adapted to not interfere with the reciprocating movement of valve 214. Once lower filter 100 is positioned within seat 212, guide 220 is pressed into seat 212. As a result, lower filter is retained between guide 220 and seat 212. Lower filter 100 is preferably placed into the seat blank prior to the seat finish operations.

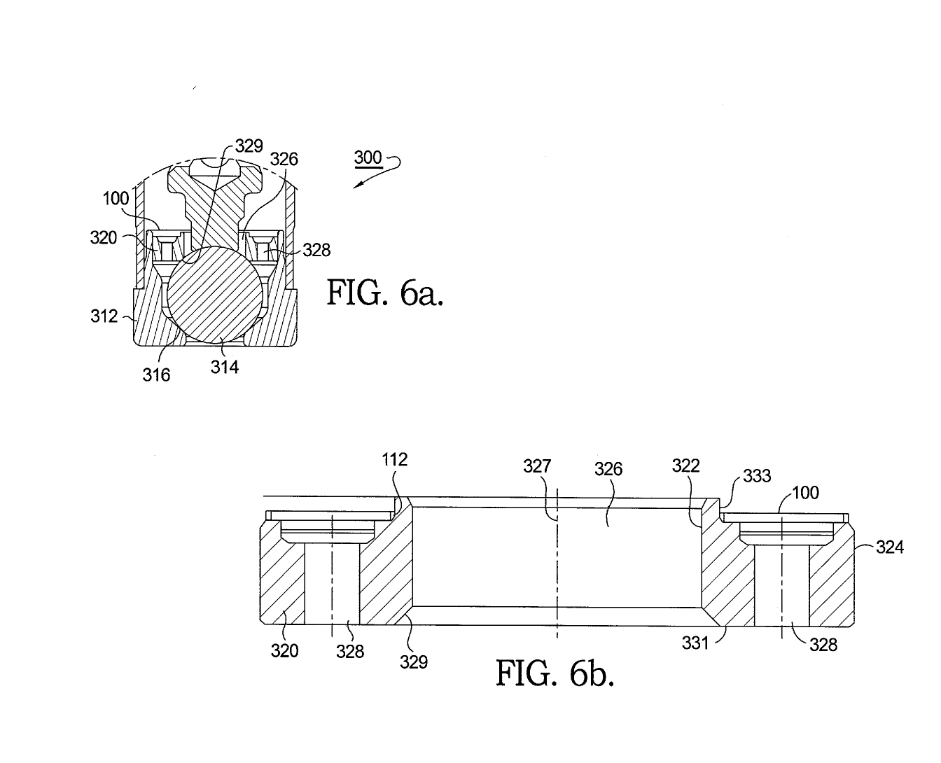

Referring to FIG. 6a, a cartridge assembly of a second embodiment 300, in accordance with the invention is shown, wherein a ball stop 320 instead of a ball guide is used to retain lower filter 100. Ball stop 320, positioned in close proximity and upstream of valve 314 and seat 312 aligns and guides valve 314 for proper sealing against seat 312. Ball stop 320 limits thee upward travel of valve 314 during injector operation.

Lower filter 100 is retained by ball stop 320 to capture contamination particulates that may be generated internally in the injector 300 before reaching valve and seat interface 316.

Referring to FIG. 6a and b, lower filter 100 is shown assembled within ball stop 320 which, in turn, is shown assembled in seat 312 of fuel injector 300. Ring-like ball stop 320 includes inner circumferential surface 322, outer circumferential surface 324 and through orifice 326. A plurality of flow through holes 328 are included, aligned substantially parallel with a centerline 327 of through orifice 326 allowing fuel flow through guide 320. A chamfer 329 is formed at the intersection of through orifice 326 and a surface 331 of ball stop 320 facing valve 314 to provide a mating contact surface for valve 314. Outer circumferential surface 324 of ball stop 320 is adapted to be received by seat 312 in a press fit arrangement.

Lower filter 100 may be assembled within ball stop 320 by either crimping or press fitting. If assembled by crimping, during the crimping process, a portion of ball stop 320, for example in the area noted in FIG. 6b as numeral 333, is deformed such that a crimp is formed that partially extends over inner diameter 112 of lower filter 100. When lower filter 100 is press fitted into ball stop 320, a disk 110 may be used that has a smaller inner diameter 112 than a lower filter 100 that is used for the crimp retention.

Lower filter 100 is preferably assembled, either by crimping or press fitting, within ball stop 320 after ball stop 320 is pressed into the seat blank and after the seat finish operations have been completed, but it may be possible to assemble lower filter 100 into ball stop 320 prior to the seat finishing operations.

By capturing and containing contaminants generated within a fuel injector by lower filter 100 as shown in FIGS. 2, 5 and 6a, the occurrence of injector failure events, such as a stuck open condition, can be reduced.

By installing lower filter 100 within or below a valve guide 220 or within ball stop 320, no additional components are required to retain lower filter 100.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A filter for a fuel injector, comprising:
a generally planar disk having an annular shape and including a plurality of filter holes;
a lower member of said fuel injector received by an injector seat;
wherein said disk is retained by said lower member; and
wherein said disk is configured to prevent contamination particles originated internally of said fuel injector from becoming lodged between said valve seat and a valve of said fuel injector.

2. The filter of claim 1, wherein said lower member is a valve guide.

3. The filter of claim 2, wherein said disk is positioned within said valve guide.

4. The filter of claim 3, wherein said disk is retained within said valve guide by a crimp formed by deformation of an inner flange of said valve guide, wherein said crimp extends over an inner diameter of said disk.

5. The filter of claim 3, wherein said disk is retained within said valve guide by a crimp formed by deformation of an outer flange of said valve guide, wherein said crimp extends over an outer diameter of said disk.

6. The filter of claim 2, wherein said disk is configured to be press fitted into said valve guide.

7. The filter of claim 2, wherein said disk is positioned below said valve guide, and wherein said disk is disposed between said valve seat and said valve guide.

8. The filter of claim 2, wherein said filter holes are photochemically etched holes.

9. The filter of claim 2, wherein each of said filter holes has a width that is smaller than a distance between a valve and said valve seat when said valve is in a full open position.

10. The filter of claim 1, wherein said lower member is a ball valve stop.

11. The filter of claim 10, wherein said disk is retained within said ball valve stop by a crimp formed by deformation of an outer flange of said ball valve stop, wherein said crimp extends over an outer diameter of said disk.

12. The filter of claim 10, wherein said disk is configured to be press fitted into said ball valve stop.

13. A valve assembly of a fuel injector, comprising:
a seat;
a reciprocably actuated valve that mates with said seat at a valve and seat interface;
a guide positioned upstream of said valve and seat interface and guiding said valve; and
a filter including a plurality of filter holes, said filter being retained by said guide;
wherein said filter is adapted to prevent contamination particles originated internally of said fuel injector from becoming lodged between said valve and said valve seat, said valve seat being disposed downstream of said guide.

14. The valve assembly of claim 13, wherein said guide includes an inner flange and an outer flange connected by a bottom wall, wherein at least one of said flanges is deformed to extend over said filter received by said guide.

15. The valve assembly of claim 13, wherein said filter is adapted to provide an interference fit with at least one of an outer diameter and an inner diameter with said guide, and wherein said filter is press fitted into said guide.

16. The internal valve assembly of claim 13, wherein said filter is positioned between said seat and said guide, and wherein said filter is retained within said seat by said guide.

17. A valve assembly of a fuel injector, comprising:
a seat;
a reciprocably actuated valve that mates with said seat at a valve and seat interface;
a ball valve stop positioned upstream of said valve and seat interface; and
a filter including a plurality of filter holes, said filter being retained by said ball valve stop;
wherein said filter is adapted to prevent contamination particles originated internally of said fuel injector from becoming lodged between said valve and said valve seat, said valve seat being disposed downstream of said ball valve stop.
